(19) United States
(12) Patent Application Publication
(10) Pub. No.: US 2014/0292638 A1
(43) Pub. Date: Oct. 2, 2014

(54) COMPUTING SYSTEM AND METHOD FOR AUTOMATICALLY DETECTING FATIGUE STATUS OF USER

(71) Applicant: WISTRON CORP., New Taipei City (TW)

(72) Inventor: Yu-Ting LEE, New Taipei City (TW)

(73) Assignee: WISTRON CORP., New Taipei City (TW)

(21) Appl. No.: 13/958,336

(22) Filed: Aug. 2, 2013

(30) Foreign Application Priority Data
Mar. 29, 2013 (TW) 102111447

(51) Int. Cl. G06F 3/01; G06K 9/00

(52) U.S. Cl. CPC G06F 3/013; G06K 9/00221
USPC 345/156

(57) ABSTRACT

Disclosed herein are a computing system and method for automatically detecting the fatigue status of a user. The computing system includes a display unit, a storage unit, an image-capturing unit and a processing unit. The storage unit is configured to store an operating system and an application. The image-capturing unit is configured to capture a facial image of the user. The processing unit is configured to execute the application in the operating system. The application is configured to analyze the change of the color of the user's eye in the facial image so as to determine whether the user is in a fatigue state. When it is determined that the user is in the fatigue state, the application prompts the display unit to present a warning window.

### RELATED APPLICATIONS

This application claims priority to Taiwanese Patent Application No. TW 102111447, filed Mar. 29, 3013, the entirety of which is herein incorporated by reference.

### BACKGROUND

1. Technical Field

The present disclosure relates to a computer system, and more particularly, a computer system and method for automatically detecting a fatigue status of a user.

2. Description of Related Art

Modern people may spend hours on using computer everyday. It is reported that minors are apt to unknowingly surf the Internet or playing computer games too much time. Staring at the screen of the computer at short distance may cause discomfort in eyes or body, which adds the burden health in the long term. To address this issue, one approach is to automatically shutdown the computer after a certain period of time. However, human are individually differentiated to each other and may have various fatigue tolerances in the use of the computer.

In view of the foregoing, there exist problems and disadvantages in the related art for further improvement; however, those skilled in the art sought vainly for a suitable solution. In order to solve or circumvent above problems and disadvantages, there is an urgent need in the related field to automatically detect a fatigue status for a user of the computer.

### SUMMARY

The following presents a simplified summary of the disclosure in order to provide a basic understanding to the reader. This summary is not an extensive overview of the disclosure and it does not identify key/critical components of the present invention or delineate the scope of the present invention. Its sole purpose is to present some concepts disclosed herein in a simplified form as a prelude to the more detailed description that is presented later.

In one aspect, the present disclosure provides a computer system and method for automatically detecting the fatigue status of a user.

The computer system provided by the present disclosure includes a display unit, a storage unit, an image-capturing unit and a processing unit. The storage unit is configured to store an operating system and an application; the image-capturing unit is configured to capture a facial image of the user; the processing unit is configured to execute the application in the operating system; the application is configured to analyze the change of the color of the user's eye in the facial image, and based on the analysis result to determine whether the user is in a fatigue state, and prompt the display unit to present a warning window when it is determined that the user is in the fatigue state.

In an embodiment, the warning window includes an inquiry message inquiring whether or not to enter a standby mode, and the computer system further includes an input device. The input device is configured such that when it receives an acceptance-information inputted by the user in response to the inquiry message, the application notifies the operating system to enter the standby mode, so that the computer system enters the standby mode.

Further, the application calculates the duration of the standby mode, such that when the duration does not exceed a predetermined rest time and the input device is configured to wake up the computer system, prompt the display unit to present a password-inquiring window.

Moreover, the computer system further includes a basic input/output system (BIOS). The non-volatile random access memory of the BIOS is configured to store a BIOS password, such that when the input device receives the inputted password inputted by the user in response to the password-inquiring window, the application compares whether the inputted password matches the BIOS password, and when the inputted password matches the BIOS password, restore the standby mode to a working mode.

In another embodiment, the warning window includes an inquiry message inquiring whether or not to enter a standby mode, and the computer system further includes an input device. The input device is configured such that when it receives a rejection-information inputted by the user in response to the inquiry message, the application, after a preset time, re-determines whether the user is in the fatigue state.

Moreover, the application calculates the accumulated number of times of the rejection-information continuously received by the input device, such that when the accumulated number of times exceeds a predetermined number of times, the application notifies the operating system to enter the standby mode, so that the computer system enters the standby mode. When the input device is configured to wake up the computer system, the application prompts the display unit to present a password-inquiring window.

Moreover, the computer system further includes BIOS. The non-volatile random access memory of the BIOS is configured to store a BIOS password, such that when the input device receives an inputted password by the user in response to the password-inquiring window, the application compares whether the inputted password matches the BIOS password, and when the inputted password matches the BIOS password, restore the standby mode to a working mode.

In still another embodiment, the application detects the change of the color of the user's eye due to the change of the human eye from an eye-ball image to an eye-lid image, and sets a critical frequency based on a frequency of the color change during an initial period; and after the initial period, when the frequency of the color change exceeds the critical frequency, determines that the user is in the fatigue state.

In yet another embodiment, the application analyzes a ratio of the image of the redness of the eye to the image of the eye white, and when the ratio exceeds a preset value, determines that the user is in the fatigue state.

The present disclosure provides a method for automatically detecting the fatigue status of a user, which is suitable for use in a computer system, and includes: capturing a facial image of the user; analyzing the change of the color of the user's eye in the facial image, and determining that whether the user is in a fatigue state based on the analysis result, and prompting a display unit to present a warning window when it is determined that the user is in the fatigue state.

In an embodiment, the warning window includes an inquiry message inquiring whether or not to enter a standby mode, and the method further includes: when an input device receives an acceptance-information by the user in response to the inquiry message, making the computer system enter the standby mode.

Moreover, the method further includes: calculating the duration of the standby mode, the duration does not exceed a predetermined rest time and the input device is configured to wake up the computer system, prompting the display unit to present a password-inquiring window.

Moreover, the method further includes: when the input device receives the inputted password inputted by the user in response to the password-inquiring window, comparing whether the inputted password matches the BIOS password; and when the inputted password matches the BIOS password, restoring the computer system from the standby mode to a working mode.

In another embodiment, the warning window includes an inquiry message inquiring whether or not to enter a standby mode, and the method further includes: when an input device receives a rejection-information inputted by the user in response to the inquiry message, re-determining whether the user is in the fatigue state after a preset time.

Moreover, the method further includes: the accumulated number of times of the rejection-information continuously received by the input device, such that when the accumulated number of times exceeds a predetermined number of times, making the computer system enter the standby mode.

Moreover, the method further includes: when the input device is configured to wake up the computer system, prompting the display unit to present a password-inquiring window

Moreover, the method further includes: when the input device receives an inputted password by the user in response to the password-inquiring window, comparing whether the inputted password matches the BIOS password, and when the inputted password matches the BIOS password, restoring the computer system from the standby mode to a working mode.

In still another embodiment, the step of analyzing the change of the color of the user's eye in the facial image and determining that whether the user is in a fatigue state based on the analysis result includes: detecting the change of the color of the user's eye due to the change of the human eye from an eye-ball image to an eye-lid image; setting a critical frequency based on a frequency of the color change during an initial period; and after the initial period, when the frequency of the color change exceeds the critical frequency, determining that the user is in the fatigue state.

In yet another embodiment, the step of analyzing the change of the color of the user's eye in the facial image and determining that whether the user is in a fatigue state based on the analysis result includes: analyzing a ratio of the image of the redness of the eye to the image of the eye white, and when the ratio exceeds a preset value, determining that the user is in the fatigue state.

In view of the foregoing, the technical solutions of the present disclosure result in significant advantageous and beneficial effects, compared with existing techniques. The implementation of the above-mentioned technical solutions achieves substantial technical improvements and provides utility that is widely applicable in the industry. Specifically, technical advantages generally attained, by embodiments of the present invention, include:
1. The present disclosure begins from the health concern of the human body to detect the fatigue level of the user's eyes; when the body is getting tired, the eyes are getting gazed and un-focused, and if the system detects that the fatigue occurs too often, it warns the user about the potential fatigue state, and thereby reminds the user to take appropriate reset; and
2. All the user need is to install the application to activate the present method, there is no need for extra devices, the present disclosure helps the parents to monitor how many times do children spend on the computer, or to correct the over-use habit of the general population.

Many of the attendant features will be more readily appreciated, as the same becomes better understood by reference to the following detailed description considered in connection with the accompanying drawings.

### BRIEF DESCRIPTION OF THE DRAWINGS

The present description will be better understood from the following detailed description read in light of the accompanying drawing, wherein:

FIG. 1 is a block diagram illustrating a computer system for automatically detecting the fatigue status of a user according to one embodiment of the present disclosure;

FIG. 2 is a flow diagram illustrating a method for automatically detecting the fatigue status of a user according to one embodiment of the present disclosure; and

FIG. 3 is a flow diagram illustrating one embodiment of the present disclosure for detecting the fatigue level of human eyes.

### DETAILED DESCRIPTION

In the following detailed description, for purposes of explanation, numerous specific details are set forth in order to attain a thorough understanding of the disclosed embodiments. In accordance with common practice, the various described features/elements are not drawn to scale but instead are drawn to best illustrate specific features/elements relevant to the present invention. Also, like reference numerals and designations in the various drawings are used to indicate like elements/parts. Moreover, well-known structures and devices are schematically shown in order to simplify the drawing and to avoid unnecessary limitation to the claimed invention.

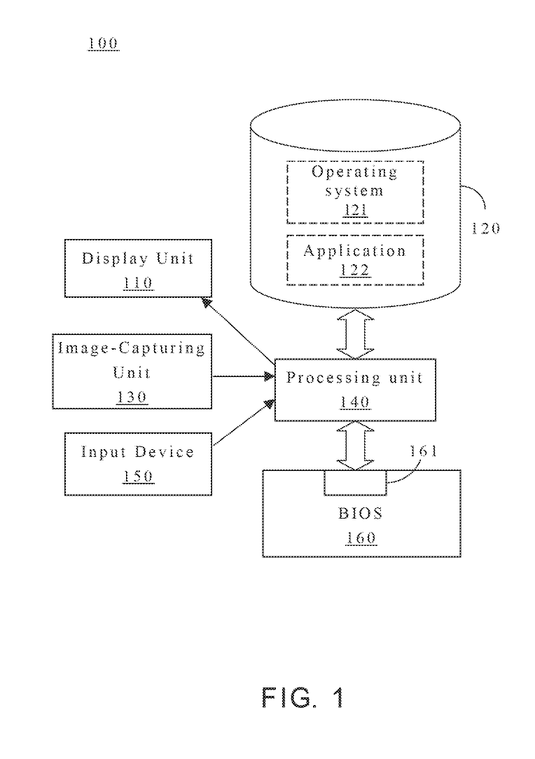

FIG. 1 is a block diagram illustrating a computer system 100 for automatically detecting the fatigue status of a user according to one embodiment of the present disclosure. As illustrated in FIG. 1, the computer system 100 includes a display unit 110, a storage unit 120, an image-capturing unit 130, a processing unit 140, an input device 150 and a BIOS 160. Structurally, the display unit 110, the storage unit 120, the image-capturing unit 130, the input device 150 and the BIOS 160 are connected to the processing unit 140.

In practice, the computer system 100 can be any electronic products, such as: notebooks, desktop computers, smartphones, tablet computers . . . etc. The image-capturing unit 130 can be a built-in or an external camera of the electronic product, the display unit 110 can be a liquid crystal screen or other flat panel apparatus, the processing unit 140 can be a central processing unit, microprocessor, or similar component architecture, the input device 150 can be a keyboard, mouse, touch screen voice control device or other input apparatus, the storage unit 120 can be a hard drive, flash memory or other computer-readable recording medium.

The storage unit 120 is configured to store an operating system 121 and an application 122. When the user uses the input device 150 to open the application 122, the processing unit 140 executes the application 122 in the operating system 121, and the image-capturing unit 130 also captures a facial image of the user; the application 122 analyzes the change of the color of the user's eye in the facial image, and based on the analysis result to determine that whether the user is in a fatigue state; and when it is determined that the user is in the fatigue state, the application 122 prompts the display unit 110 to present a warning window thereby reminding the user to take some appropriate rest.

Said warning window may include an inquiry message inquiring whether or not to enter a standby mode. If the user intends to make the computer system 100 enter the standby mode, he/she may input an acceptance-information through the input device 150, and when the input device 150 receives the acceptance-information inputted by the user in response to the inquiry message, the application 122 notifies the operating system 121 to enter the standby mode, so that the computer system 100 enters the standby mode, and thereby allows the user to take some appropriate rest.

In the meantime, the application 122 calculates the duration of the standby mode. When the duration of the standby mode exceeds a predetermined rest time (e.g., 10 minutes), it indicates that the user has taken enough rest. In this case, if the user uses the input device 150 to wake up the computer system 100, the computer system 100 will restore to the working mode, and re-start to detect whether the user is in the fatigue state. On the other hand, when the duration of the standby mode does not exceed the predetermined rest time (e.g., 10 minutes), it means that the user may not take enough rest. In this circumstance, if the input device 150 is used by the user to wake up the computer system 100, the application 122 prompts the display unit 110 to present a password-inquiring window, so that the user has to input the correct password to restore the computer system to the working mode.

In an embodiment, the correct password may be a set of passwords that is set by the user through the application 122 in advanced. Alternatively, in another embodiment, the correct password is a BIOS password stored in the non-volatile random access memory 161 of the BIOS 160; and when the computer system 100 is decided to enter the standby mode by the application 122, the application 122 also notifies the BIOS 160, and the BIOS 160 open associated ASL codes, so that the computer system 100 present the password-inquiring window when it is woken up from the standby mode such that when the input device 150 receives the inputted password inputted by the user in response to the password-inquiring window, the application 122 compares whether the inputted password matches the BIOS password, and when the inputted password matches the BIOS password, restores the standby mode to a working mode. In this way, the user may use the computer system 100 ahead of schedule and does not have to wait until the elapse of the predetermined rest time. In contrast, if the user inputs a wrong password, i.e., the inputted password does not match the BIOS password, the computer system 100 remains in the standby mode and wait until the elapse of the predetermined rest time.

On the other hand, when the warning window popped out by the display unit 110 includes an inquiry message inquiring whether or not to enter a standby mode, if the user refuses to let the computer system 100 enter the standby mode, he/she may input a rejection-information through the input device 150, and the input device 150 is configured such that whenever it receives a rejection-information inputted by the user in response to the inquiry message, the application 122, after a preset time (e.g., 5 minutes), re-determines whether the user is in the fatigue state; and if the user is still in the fatigue state, the application 122 prompts the display unit 110 to present said inquiry message once again.

Moreover, the application 122 calculates the accumulated number of times of the rejection-information continuously received by the input device 150. When the accumulated number of times exceeds a predetermined number of times (e.g., 5 times), it indicates that the use's body has been quite tired, and to avoid the user from falling ill from constant overwork, the application 122 actively notifies the operating system 121 to enter the standby mode, so that the computer system 100 enters the standby mode, thereby allowing the user to take some appropriate rest to prevent the illness.

If the user insists on using the computer system 100, he/she can still use the input device 150 to wake up the computer system 100. In this case, the application 122 prompts the display unit 110 to present a password-inquiring window. The user has to input the correct password so as to make the computer system 100 return to the working mode. The correct password may be a set of passwords preset by the user through the application 122 or a BIOS password, and persons having ordinary skills in the art make flexible select the suitable option depending on the need. In contrast, if the user inputs a wrong password, i.e., the inputted password does not match the BIOS password, the computer system 100 remains in the standby mode.

With respect to how the application 122 detects whether the user has been in the fatigue state, the present disclosure provides solutions using the dynamic color block algorithm so that the color serves as the basis for determination. The feature of the human eye is different from that of the other body part since the eye-lid, eye white and eye-ball have different colors. When the application 122 is open, it calculates from the feature value to identify the block(s) in which the human eye locates, then the application 122 captures and records an eye blink frequency of the user during an initial period (e.g., the first 3 minutes) when the user uses the computer system 100. During the initial period, the user hasn't started to feel tired or fatigue, and hence the eye blink frequency is within a normal range. If the change of the color in the block(s) of the eye is elevated or more frequent (that is, the eye blink frequency increases), the image-capturing unit 130 will detect the frequent change of color in the block(s) of the eye; thereby leading to the determination that the user has been in the fatigue state.

Specifically, the application 122 detects the change of the color of the user's eye due to the change of the human eye from an eye-ball image to an eye-lid image and thereby defines the eye blink. The application 122 sets a critical frequency based on a frequency of the change of the color during an initial period, in which the frequency of the change of the color during the initial period represents the normal eye blink frequency and the critical frequency is the presumed eye blink frequency when the user is in the fatigue state. In practice, different frequencies of the change of the color may correspond to different critical frequencies. For example, when the user is energetic, the frequency of the change of the color during the initial period may be once about every 10 seconds, and the critical frequency can be set as once every 3 seconds; alternatively, when the user is in an average state, the frequency of the change of the color during the initial period may be once about every 5-7 seconds, and the critical frequency can be set as once every 1-2 seconds. Next, after the initial period, when the frequency of the change of the color exceeds the critical frequency, the application 122 determines that the user is in the fatigue state.

Alternatively or additionally, in another embodiment, the application 122 analyzes a ratio of the image of the redness of the eye to the image of the eye white, and when the ratio exceeds a preset value (indicating that the eye is bloodshot), the application 122 determines that the user is in the fatigue state. In practice, the preset value may be flexibly chosen depending on the actual condition.

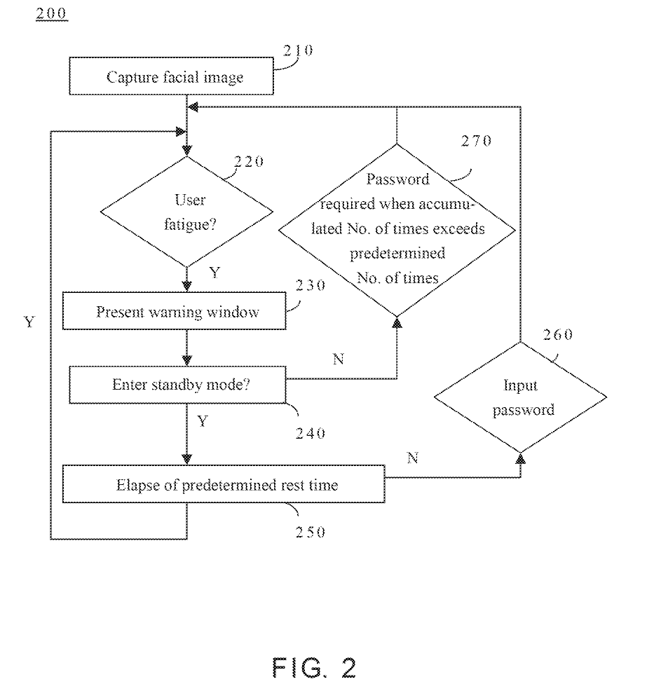

FIG. 2 is a flow diagram illustrating a method 200 for automatically detecting the fatigue status of a user according to one embodiment of the present disclosure. As illustrated in FIG. 2, the method 200 comprises steps 210-270. As could be appreciated, the steps recited in the present embodiment, are not recited in the sequence in which the steps are performed, unless the sequence of the steps is expressly indicated. Rather, the sequence of the steps is interchangeable, and all or part of the steps may be simultaneously, partially simultaneously, or sequentially performed. Also, since the hardware devices for implementing these steps have been specifically disclosed above, detailed description thereof is omitted herein for the sake of brevity.

In step 210, capture a facial image of the user. Next, in step 220, analyze the change of the color of the user's eye in the facial image, and determine that whether the user is in a fatigue state is made based on the analysis result. When it is determined that the user in the fatigue state, in step 230, prompt a display unit to present a warning window so as to remind the user to take some appropriate rest.

In step 230, the warning window includes an inquiry message inquiring whether or not to enter a standby mode, and if the user intends to let the computer system enter the standby mode, he/she may input an acceptance-information through an input device, and when the input device receives the acceptance-information inputted by the user in response to the inquiry message, in step 240, let the computer system enter the standby mode, and allow the user to take some appropriate rest.

Then, in step 250, calculate the duration of the standby mode; when the duration of the standby mode exceeds a predetermined rest time (e.g., 10 minutes), it indicates that the user has taken enough rest; and hence if the user uses the input device to wake up the computer system, restore the computer system to the working mode, and in step 220, re-start to detect whether the user is in the fatigue state. On the other hand, when the duration of the standby mode does not exceed the predetermined rest time (e.g., 10 minutes), it means that the user may not take enough rest, and if the input device is used by the user to wake up the computer system, in step 260, prompt the display unit to present a password-inquiring window, so that the user has to input the correct password to restore the computer system to the working mode.

In step 260, the correct password may be a set of passwords that is set by the user through the application 122 in advanced; alternatively, in another embodiment, the correct password is a BIOS password stored in the non-volatile random access memory of the BIOS; and when the input device receives the inputted password inputted by the user in response to the password-inquiring window, compare whether the inputted password matches the BIOS password, and when the inputted password matches the BIOS password, restore the computer system from the standby mode to a working mode, and return to step 220 to re-star to detect whether the user is in the fatigue state. In this way, the user may use the computer system ahead of schedule and does not have to wait until the elapse of the predetermined rest time. In contrast, if the user inputs a wrong password, i.e., the inputted password does not match the BIOS password, the computer system remains in the standby mode and wait until the elapse of the predetermined rest time.

On the other hand, in step 230, when the warning window includes an inquiry message inquiring whether or not to enter a standby mode, if the user refuses to let the computer system enter the standby mode, he/she may input a rejection-information through the input device, and the input device is configured such that whenever it receives a rejection-information inputted by the user in response to the inquiry message, in step 270, re-determine whether the user is in the fatigue state after a preset time (e.g., 5 minutes); and if the user is still in the fatigue state, prompt the display unit to present said inquiry message once again.

Moreover, in step 270, calculate an accumulated number of times of the rejection-information continuously received by the input device. When the accumulated number of times exceeds a predetermined number of times (e.g., 5 times), it indicates that the use's body has been quite tired, and to avoid the user from falling ill from constant overwork, actively notify the operating system to enter the standby mode, so that the computer system enters the standby mode, thereby allowing the user to take some appropriate rest to prevent the illness.

If the user insists on using the computer system, he/she can still use the input device to wake up the computer system, in step 270, prompt the display unit to present a password-inquiring window. The user has to input the correct password so as to make the computer system 100 return to the working mode. The correct password may be a set of passwords preset by the user through the application or a BIOS password, and persons having ordinary skills in the art make flexible select the suitable option depending on the need. In contrast, if the user inputs a wrong password, i.e., the inputted password does not match the BIOS password, the computer system remains in the standby mode.

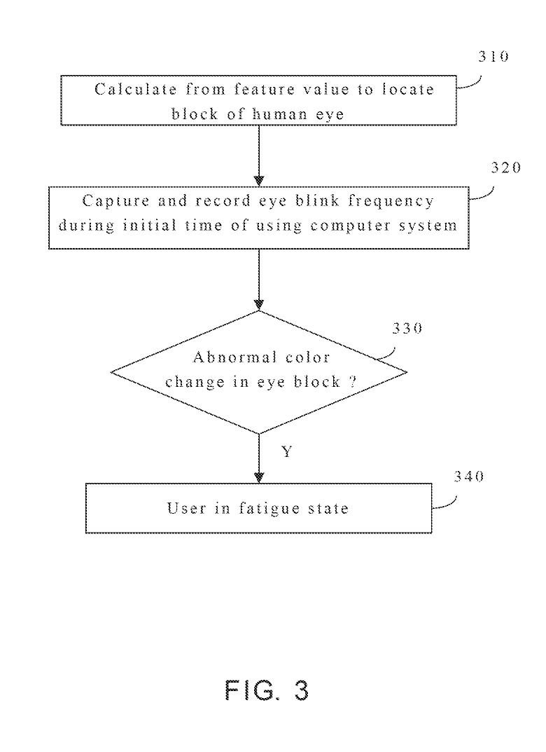

FIG. 3 is a flow diagram illustrating one embodiment of the present disclosure for detecting the fatigue level of human eyes. The dynamic color block algorithms provided by the present disclosure is illustrated in FIG. 3, in which the colors serve as the basis for determination because the feature of the human eye is different from that of the other body part. In step 310, based on the different colors of the eye-lid and eye white or eye-ball, calculate from the feature value to identify the block(s) in which the human eye locates, then in step 320, capture and record an eye blink frequency of the user during an initial period (e.g., the first 3 minutes) when the user uses the computer system. During the initial period, the user hasn't started to feel tired or fatigue, and hence the eye blink frequency is within a normal range; if the change of the color in the block(s) of the eye is elevated or more frequent (that is, the eye blink frequency increases), in step 330, use the image-capturing unit to detect the frequent change of color in the block(s) of the eye; and thereby in step 340, determine that the user has been in the fatigue state.

The above-mentioned process for detecting the fatigue level of the human eye could be applied to the step 220 in FIG. 2, which involves: detecting the change of the color of the user's eye due to the change of the human eye from an eye-ball image to an eye-lid image and thereby defines the eye blink; setting a critical frequency based on a frequency of the change of the color during an initial period, in which the frequency of the change of the color during the initial period represents the normal eye blink frequency and the critical frequency is the presumed eye blink frequency when the user is in the fatigue state; and then, after the initial period, determining that the user is in the fatigue state when the frequency of the change of the color exceeds the critical frequency.

Alternatively or additionally, in step 220, analyze a ratio of the image of the redness of the eye to the image of the eye white, and when the ratio exceeds a preset value (indicating that the eye is bloodshot), determine that the user is in the fatigue state. In practice, the preset value may be flexibly chosen depending on the actual condition.

In view of the foregoing, the present invention begins from the health concern of the human body to detect the fatigue level of the user's eyes; when the body is getting tired, the eyes are getting gazed and un-focused, and if the system detects that the fatigue occurs too often, it warns the user about the potential fatigue state, and thereby reminds the user to take appropriate reset.

Although various embodiments of the invention have been described above with a certain degree of particularity, or with reference to one or more individual embodiments, they are not limiting to the scope of the present disclosure. Those with ordinary skill in the art could make numerous alterations to the disclosed embodiments without departing from the spirit or scope of this invention. Accordingly, the protection scope of the present disclosure shall be defined by the accompany claims.

What is claimed is:

1. A computer system for automatically detecting the fatigue status of a user, the computer system comprising:
a display unit;
a storage unit, configured to store an operating system and an application;
an image-capturing unit, configured to capture a facial image of the user; and
a processing unit, configured to execute the application in the operating system, wherein the application analyzes a change of the color of the user's eye in the facial image, and determines whether the user is in a fatigue state based on the analysis result; and when it is determined that the user is in the fatigue state, the application prompts the display unit to present a warning window.

2. The computer system according to claim 1, wherein the warning window includes an inquiry message inquiring whether or not to enter a standby mode, and the computer system further comprises:
an input device, configured such that when it receives an acceptance-information inputted by the user in response to the inquiry message, the application notifies the operating system to enter the standby mode, so that the computer system enters the standby mode.

3. The computer system according to claim 2, wherein the application calculates a duration of the standby mode, such that when the duration does not exceed a predetermined rest time and the input device is configured to wake up the computer system, the application prompts the display unit to present a password-inquiring window.

4. The computer system according to claim 3, further comprising:
a basic input/output system (BIOS), wherein the non-volatile random access memory thereof is configured to store a BIOS password, such that when the input device receives an inputted password inputted by the user in response to the password-inquiring window, the application compares whether the inputted password matches the BIOS password, so that when the inputted password matches the BIOS password, restores the standby mode to a working mode.

5. The computer system according to claim 1, wherein the warning window comprises an inquiry message inquiring or not to enter a standby mode, and the computer system further comprises:
an input device, configured such that whenever it receives a rejection-information inputted by the user in response to the inquiry message, the application re-determines whether the user is in the fatigue state after a preset time.

6. The computer system according to claim 5, wherein the application calculates an accumulated number of times of the rejection-information continuously received by the input device, such that when the accumulated number of times exceeds a predetermined number of times, the application notifies the operating system to enter the standby mode, so that the computer system enters the standby mode.

7. The computer system according to claim 6, wherein when the input device is configured to wake up the computer system, the application prompts the display unit to present a password-inquiring window.

8. The computer system according to claim 7, further includes:
a BIOS, wherein the non-volatile random access memory thereof is configured to store a BIOS password, such that when the input device receives an inputted password inputted by the user in response to the password-inquiring window, the application compares whether the inputted password matches the BIOS password, so that when the inputted password matches the BIOS password, restores the standby mode to a working mode.

9. The computer system according to claim 1, wherein the application detects the change of the color of the user's eye due to the change of the human eye from an eye-ball image to an eye-lid image; sets a critical frequency based on a frequency of the change of the color during an initial period; and when the frequency of the change of the color exceeds the critical frequency after the initial period, determines that the user is in the fatigue state.

10. The computer system according to claim 1, wherein the application analyzes a ratio of the image of the redness of the eye to the image of the eye white, and when the ratio exceeds a preset value, determines that the user is in the fatigue state

11. A method for automatically detecting the fatigue status of a user, wherein the method is suitable for use in a computer system and comprises:
capturing a facial image of the user; and
analyzing a change of the color of the user's eye in the facial image, determining whether the user is in a fatigue state based on the analysis result, and when it is determined that the user is in the fatigue state, prompting the display unit to present a warning window

12. The method according to claim 11, wherein the warning window includes an inquiry message inquiring whether or not to enter a standby mode, and the method further comprises:
making the computer system enter the standby mode, when an input device receives an acceptance-information inputted by the user in response to the inquiry message.

13. The method according to claim 12, further comprising:
calculating a duration of the standby mode, such that when the duration does not exceed a predetermined rest time and the input device is configured to wake up the computer system, prompting the display unit to present a password-inquiring window.

14. The method according to claim 13, further comprising:
comparing whether the inputted password matches a BIOS password, when the input device receives an inputted password inputted by the user in response to the password-inquiring window; and
restoring the computer system from the standby mode to a working mode, when the inputted password matches the BIOS password.

15. The method according to claim 11, wherein the warning window comprises an inquiry message inquiring or not to enter a standby mode, and the method further comprises:
re-determining whether the user is in the fatigue state after a preset time, whenever an input device receives a rejection-information inputted by the user in response to the inquiry message.

16. The method according to claim 15, further comprising:
calculating an accumulated number of times of the rejection-information continuously received by the input device, such that when the accumulated number of times exceeds a predetermined number of times, making the computer system enter the standby mode.

17. The method according to claim 16, further comprising:
prompting the display unit to present a password-inquiring window when the input device is configured to wake up the computer system.

18. The method according to claim 17, further comprising:
comparing whether the inputted password matches the BIOS password when the input device receives an inputted password inputted by the user in response to the password-inquiring window, so that when the inputted password matches the BIOS password, restoring the standby mode to a working mode.

19. The method according to claim 11, wherein the step of analyzing the change of the color of the user's eye in the facial image, and determining whether the whether the user is in a fatigue state based on the analysis result comprise:
detecting the change of the color of the user's eye due to the change of the human eye from an eye-ball image to an eye-lid image;
setting a critical frequency based on a frequency of the change of the color during an initial period; and
after the initial period, determining that the user is in the fatigue state when the frequency of the change of the color exceeds the critical frequency.

20. The method according to claim 11 wherein the step of analyzing the change of the color of the user's eye in the facial image, and determining whether the whether the user is in a fatigue state based on the analysis result comprise:
analyzing a ratio of the image of the redness of the eye to the image of the eye white; and
determining that the user is in the fatigue state when the ratio exceeds a preset value.
